(19) United States
(12) Patent Application Publication
(10) Pub. No.: US 2015/0062871 A1
(43) Pub. Date: Mar. 5, 2015

(54) OPTICAL PLATE, METHOD OF MANUFACTURING THE SAME, AND BACKLIGHT ASSEMBLY HAVING THE SAME

(71) Applicant: Samsung Display Co., Ltd., Yongin-City (KR)

(72) Inventors: Joong Hyun KIM, Asan-si (KR); Tae Yong RYU, Hwaseong-si (KR); Seung Hwan CHUNG, Asan-si (KR)

(73) Assignee: Samsung Display Co., Ltd., Yongin-City (KR)

(21) Appl. No.: 14/103,459

(22) Filed: Dec. 11, 2013

(30) Foreign Application Priority Data
Aug. 29, 2013 (KR) 10-2013-0103239

(51) Int. Cl. G02B 5/02

(52) U.S. Cl. CPC G02B 5/0236
USPC 362/97.1; 362/355

(57) ABSTRACT

An optical plate and a method of manufacturing the same are provided where the optical plate can be patterned to counter-compensate for luminance hot spots of corresponding light sources. More specifically, there is provided an optical plate comprising a substrate, and a patterned optical processing layer which is disposed on the substrate, wherein the patterned optical processing layer comprises flat area portions located close to the substrate, a plurality of protruding patterns which are located on or between the flat area portions and have concave portions formed at respective ends thereof, and a plurality of light diffusing patterns which are located on the concave portions, respectively.

This application claims priority from Korean Patent Application No. 10-2013-0103239 filed on Aug. 29, 2013 in the Korean Intellectual Property Office, the disclosure of which application is incorporated herein by reference in its entirety.

### BACKGROUND

1. Field of Disclosure

The present disclosure of invention relates to an optical plate, a method of manufacturing the same, and a backlight assembly having the same.

2. Description of Related Technology

As industrial society develops into an advanced information processing age, the importance of electronic displays as a medium for displaying and transferring various pieces of information is increasing day by day. Conventionally, a cathode ray tube (CRT), which is bulky, was widely used but faced considerable limitations for example in terms of the space required to mount it, weight and so forth thus making it difficult to manufacture CRTs having ever larger display area sizes. Accordingly, CRTs are being replaced with various types of flat or otherwise thin panel displays, including liquid crystal displays (LCDs), plasma display panels (PDPs), field emission displays (FEDs), and organic electroluminescent (EL) displays. Among such thin panel displays, in particular, LCDs, a technologically intensive product realized from a combination of liquid crystal-semiconductor techniques, are advantageous because they are slim and lightweight and consume little power. Therefore, research and development into structures and manufacturing techniques thereof is continuing. Nowadays, LCDs are already applied in fields such as notebook computers, monitors for desktop computers, and portable personal communication devices (including PDAs and mobile phones). Besides, LCDs are being applied to high-definition, large-sized TVs as technology to enlarge their display area sizes is overcoming various limitations.

In the LCD technology area, because the liquid crystals themselves do not emit light, an additional light source is provided for example at the back surface of the display panel so that the intensity of light passing through the liquid crystals in each pixel is controlled by electric field orientation of the liquid crystals to thereby realize desired contrasts. More specifically, the LCD, serving as a device for adjusting light transmittance using the electrical properties of liquid crystal material, emits light from a light source mounted to the back surface thereof, and the light thus emitted is passed through various functional optical plates to thus cause light to be of substantially uniform luminance and substantially consistent light ray directions, after which such controlled light may also passed be through a color filter, thereby realizing red, green, and blue (R, G, B) colors. In other words, the LCD is of an indirect light emission type, which realizes an image by controlling the contrast of each pixel through an electrical method. As such, a backlight assembly including a light source is an important part of determining the image quality of the LCD, including brightness and uniformity of the produced image.

The backlight assembly typically includes a light source, a reflection plate, a light guide plate (LGP), and various optical plates. Here, the optical plates may diffuse light generated from the light source, thereby causing as much of the light as possible to reach liquid crystals. In addition, the optical plates may diffuse light generated from the light source, thereby causing the light to be uniformly delivered to the whole display area of the liquid crystal display device.

As described above, the optical plates may perform a light-diffusing function. To perform this function, light diffusing patterns may be formed by printing a material (hereinafter, referred to as a diffusion material) having light-diffusing properties on a substrate. Here, the diffusion material may be printed partially rather than on the whole substrate so that it is pattern-printed to obtain desired optical properties.

However, it is difficult to make the light diffusing patterns thick with conventional ink jet printing processes. Generally, the light diffusing patterns can be formed to a thickness of no more than about 6 to 10 μm by a single printing process. In particular, when a diffusion material having a low viscosity is used, the light diffusing patterns may be formed to a thickness of no more than about 6 μm or less. The printing process can be repeated a number of times to increase the thickness of the light diffusing patterns. However, this is not only cumbersome in terms of process but also incurs large costs. In addition, it is not easy to accurately align a diffusion material of a first printed layer with a next layer which is to be additionally printed as a pattern on the already hardened first diffusion material layer which has already been printed. Furthermore, light diffusing patterns having a relatively small thickness cannot properly diffuse or reflect light as desired. In particular, light diffusing patterns with a thickness of no more than about 6 to 10 μm have an average reflexibility (efficiency in reflecting visible light) of only about 75%, and the reflexibility of the light diffusing patterns may decrease as the wavelength of light incident on the light diffusing patterns increases. If the reflexibility of the light diffusing patterns is low for light of long wavelengths, light of a long wavelength generated from the light source may exit the backlight assembly without being properly (e.g., fully) diffused by the light diffusing patterns of the optical plates. Thus, the lack of good diffusion of bluish light may cause the screen of a display device to be seen as yellowish rather than a desired full spectrum white color. This phenomenon directly affects the display quality of the display device.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides an optical plate which includes patterned light diffusing patterns having a relatively large thickness and thus good light reflection and/or diffusion properties over a wide range of wavelengths.

Aspects of the present disclosure also provide a method of manufacturing an optical plate which includes patterned light diffusing patterns having a large thickness.

Aspects of the present disclosure also provide a backlight assembly which includes an optical plate including patterned light diffusing patterns having a large thickness.

According to an aspect of the present disclosure, there is provided an optical plate comprising a substrate, and a patterned optical processing layer which is located on the substrate, wherein the patterned optical processing layer comprises flat area portions which is located on the substrate, a plurality of protruding patterns which are located on or between the flat area portions and have concave portions formed at respective free ends thereof, and a plurality of light diffusing patterns which are located on the concave portions, respectively.

A minimum thickness of the protruding patterns may be greater than a thickness of the flat area portions.

The minimum thickness of the protruding patterns may be 20 μm or more.

A maximum thickness of the light diffusing patterns may be greater than the minimum thickness of the protruding patterns.

The maximum thickness of the light diffusing patterns may be 20 to 100 μm.

The flat area portions may be monolithically integrally formed with the protruding patterns.

Each of the light diffusing patterns may comprise a base member and diffusion particles contained in the base member.

The flat area portions and the protruding patterns may be formed of first resin, and the base member may be formed of second resin, wherein the first resin and the second resin may have the property of being cured by at least one of light or heat.

The substrate may comprise one or more repeated unit cell regions, and the proportion of the light diffusing patterns in the patterned optical processing layer may increase toward a center of each of the unit cell regions.

A gap between adjacent light diffusing patterns may decrease toward the center of each of the unit regions.

A size of the light diffusing patterns may increase toward the center of each of the unit regions.

According to another aspect of the present disclosure of invention, there is provided a method of mass production manufacturing an optical plate, the method comprising forming flat area portions and a plurality of protruding patterns, which protrude from the flat area portions and have concave portions formed at respective ends thereof, on a substrate, and forming a plurality of light diffusing patterns on the concave portions, respectively.

The forming of the flat area portions and the protruding patterns may comprises forming a preliminary pattern layer on the substrate, and hot or otherwise pressing the preliminary pattern layer with a stamp having a shape corresponding to a shape of the flat area portions and the protruding patterns.

The preliminary pattern layer may be formed of first resin having the property of being cured by at least one of light or heat.

The method of manufacturing an optical plate may further comprise irradiating light or transmitting heat to the preliminary pattern layer through the stamp during or after the pressing of the preliminary pattern layer with the stamp.

The forming of the light diffusing patterns may comprise filling the concave portions with a mixture of diffusion particles and second resin, which has the property of being cured by light or heat, by using a gravure coating apparatus.

The method of manufacturing an optical plate may further comprise irradiating light or transmitting heat to the mixture after the filling of the concave portions with the mixture.

According to still another aspect of the present disclosure of invention, there is provided a backlight assembly comprising an optical plate which comprises a substrate and an patterned optical processing layer located on the substrate, and a plurality of light sources which face the patterned optical processing layer of the optical plate, wherein the patterned optical processing layer comprises flat area portions which are located on the substrate, a plurality of protruding patterns which are located on or between the flat area portions and have concave portions formed at respective ends thereof, and a plurality of light diffusing patterns which are located on the concave portions, respectively.

The substrate may comprise one or more unit regions, and the proportion of the light diffusing patterns in the patterned optical processing layer may increase toward a center of each of the unit regions.

A center of the light source may overlap the center of each of the unit regions.

### BRIEF DESCRIPTION OF THE DRAWINGS

The above and other aspects and features of the present disclosure of invention will become more apparent by describing in detail exemplary embodiments thereof with reference to the attached drawings, in which:

FIG. 1 is a plan view of an optical plate fabricated in accordance with an embodiment of the present disclosure of invention;

FIG. 2 is a cross-sectional view taken along the line II-II′ of FIG. 1;

FIGS. 3 through 5 are cross-sectional views illustrating steps of a method of manufacturing the optical plate of FIG. 1;

FIG. 6 is a graph illustrating the reflexibility of light diffusing patterns with respect to the wavelength of light incident on the light diffusing patterns;

FIG. 7 is a plan view of an optical plate according to another embodiment;

FIG. 8 is a cross-sectional view taken along the line VIII-VIII′ of FIG. 7;

FIGS. 9 and 10 are cross-sectional views of an optical plate according to other embodiments;

FIG. 11 is a plan view of a backlight assembly according to an embodiment;

FIG. 12 is a cross-sectional view taken along the line XII-XII′ of FIG. 11;

FIG. 13 is a plan view of a backlight assembly according to another embodiment; and

FIG. 14 is a cross-sectional view taken along the line XIV-XIV′ of FIG. 13.

### DETAILED DESCRIPTION

The aspects and features of the present disclosure of invention and methods for achieving the aspects and features will be apparent by referring to the exemplary embodiments to be described in detail with reference to the accompanying drawings. However, the present teachings are not limited to the embodiments disclosed hereinafter, but can be implemented in diverse forms. The matters defined in the description, such as the detailed construction and elements, are nothing but specific details provided to assist those of ordinary skill in the art in a comprehensive understanding of the present teachings.

The term “on” that is used to designate that an element is on another element or located on a different layer or a layer includes both a case where an element is located directly on another element or a layer and a case where an element is located on another element via another layer or still another element. In the entire description of the present disclosure, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

The present disclosure of invention will now be described more fully with reference to the accompanying drawings, in which exemplary embodiments of the invention are shown.

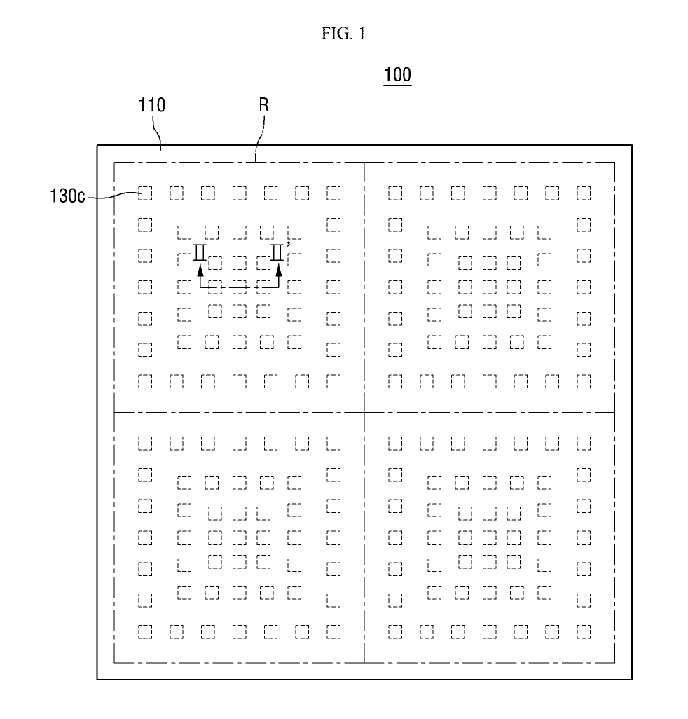

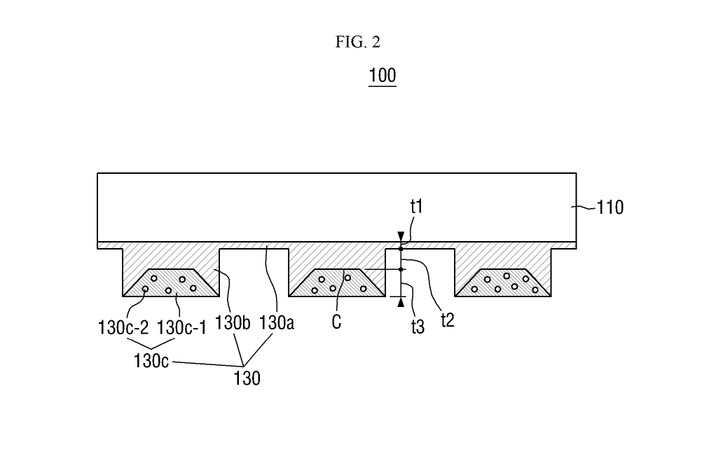

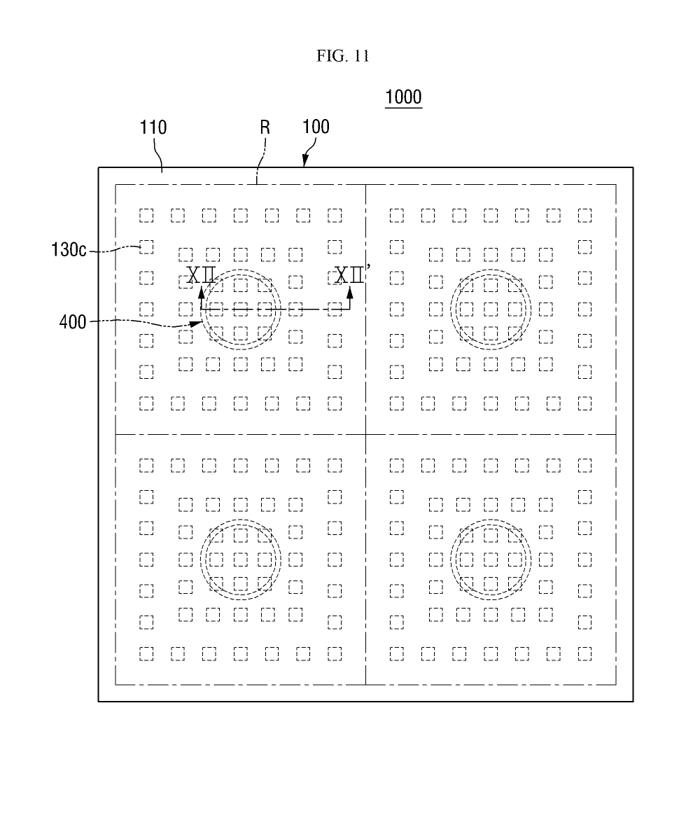

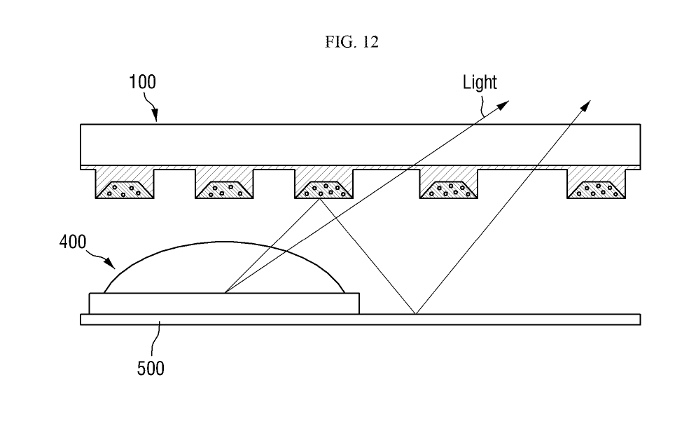

FIG. 1 is a top plan view of an exemplary optical plate 100 in accordance with the present disclosure of invention. FIG. 2 is a cross-sectional view taken along the line II-II′ of FIG. 1. Although not shown in FIGS. 1-2, it will be better appreciated from FIGS. 11-12 that the first described, optical plate 100 may be used in conjunction with an array of point light sources such as array of LEDs configured to align with and correspond to the light diffusing patterns of the first described, optical plate 100.

Referring to FIGS. 1 and 2, the optical plate 100 according to the current embodiment includes a substrate 110 and a patterned optical processing layer 130.

The substrate 110 may be formed of a transparent material. In an exemplary embodiment, the substrate 110 may be a rigid substrate that is difficult to deform. The rigid substrate may be formed of a glass material containing SiO₂ as its main component. In another exemplary embodiment, the substrate 110 may be a flexible substrate that can be easily and elastically deformed, for example, rolled, folded, bent, etc. and then flattened again. The flexible substrate may be formed of a plastic material having superior thermal resistance and durability, such as polyethylene ether phthalate, polyethylene naphthalate, polycarbonate, polyarylate, polyetherimide, polyethersulfone, or polyimide. However, the present disclosure of invention is not limited thereto, and the substrate 110 can be formed of various materials.

Light incident on the optical plate 100 may be controlled mostly by the patterned optical processing layer 130. Thus, the choice of materials for the substantially transparent substrate 110 may become relatively greater. That is, the presence of the patterned optical processing layer 130 widens the choice of substrate materials 110.

The substrate 110 may include at least one unit cell region R that is repeated across the display area of the display device in a tessellating manner. In an exemplary embodiment, the substrate 110 may include a plurality of unit regions R. As in the exemplary embodiment of FIG. 1, the unit regions R may be arranged in a matrix, but the arrangement pattern of the unit regions R is not limited to the matrix. In addition, each of the unit regions R has may have a quadrangular shape. However, the shape of each of the unit regions R is not limited to the quadrangular shape, and each of the unit regions R can have various shapes such as circular shapes and/or various polygon shapes.

The patterned optical processing layer 130 may be located on a first surface of the substrate 110. In an exemplary embodiment, the patterned optical processing layer 130 may be formed only on the first surface of the substrate 110 as shown in FIG. 2. However, the present teachings are not limited thereto, and the patterned optical processing layer 130 may also be formed on a second surface of the substrate 110 which is opposite the first surface of the substrate 110. The patterned optical processing layer 130 may change the properties of light incident onto and passing through the optical plate 100.

More specifically, the patterned optical processing layer 130 includes flat area portions 130a, a plurality of protruding patterns 130b protruding beyond the flat area portions 130a, and a plurality of light diffusing patterns 130c.

The flat area portions 130a may be formed directly on the first surface of the substrate 110. That is, the flat area portions 130a may directly contact the first surface of the substrate 110. The flat area portions 130a may fully cover the first surface of the substrate 110. However, the present teachings are not limited thereto, and the flat area portions 130a may partially cover the first surface of the substrate 110. The flat area portions 130 may be interposed between the substrate 110 and the protruding patterns 130b or scattered between spaced apart ones of the protruding patterns 130b. Portions of the flat area portions 130a on which the protruding patterns 130b are not formed may be exposed. The exposed portions of the flat area portions 130a may have substantially flat surfaces. When viewed from above, the exposed portions of the flat area portions 130a may surround respective ones of the protruding patterns 130b.

The flat area portions 130a may be formed of first resin. Here, the first resin may be transparent. In addition, the first resin may have the property of being cured by light (e.g., UV light) and/or heat. That is, the first resin may be a photocurable resin or a thermosetting resin. Moreover, a refractive index of the first resin may be different from a refractive index of the substrate 110. In an exemplary embodiment, the refractive index of a material of the flat area portions 130a may be higher than the refractive index of the substrate 110.

A thickness t1 of the flat area portions 130a may be uniform across the whole surface of the substrate 110. More specifically, the thickness t1 of the flat area portions 130a may be smaller than each of a minimum thickness t2 of the protruding patterns 130b and a maximum thickness t3 of the light diffusing patterns 130c. In an exemplary embodiment, the thickness t1 of the flat area portions 130a may be about 2 to 5 gill.

The protruding patterns 130b may be disposed on the flat area portions 130a so as to protrude beyond the uniform thickness t1 of the flat area portions 130a. The protruding patterns 130b may protrude from a surface of the flat area portions 130a in a direction perpendicular to the surface of the flat area portions 130a. In an exemplary embodiment, side surfaces of the protruding patterns 130b may be perpendicular to the surface of the flat area portions 130a. Alternatively, they may be angles and/or curved.

Each of the protruding patterns 130b may include a concave portion C formed at an end thereof. Here, the end of each of the protruding patterns 130b may be an end thereof located in a direction in which the respective one of the protruding patterns 130b protrudes. The concave portion C may be a portion of each of the protruding patterns 130b which is recessed toward the substrate 110. In the exemplary embodiment of FIG. 2, a center of the concave portion C may be parallel to the first surface of the substrate 110, and sides of the concave portion C may slope toward the substrate 110 at a predetermined angle. Accordingly, the sidewall ends of each of the protruding patterns 130b may have a sharp edge.

The protruding patterns 130b may be monolithically integrally formed with the flat area portions 130a. That is, the protruding patterns 130b and the flat area portions 130a may be connected to each other as a continuum of same and respectively patterned material. In other words, the shapes of the protruding patterns 130b and the flat area portions 130a may be formed simultaneously by a single process and from a single patternable material. In an exemplary embodiment, the protruding patterns 130b and the flat area portions 130a may be formed simultaneously by an imprinting process. However, the present disclosure of invention is not limited thereto, and the protruding patterns 130b and the flat area portions 130a can be formed simultaneously by various other processes such as a hot pressing process.

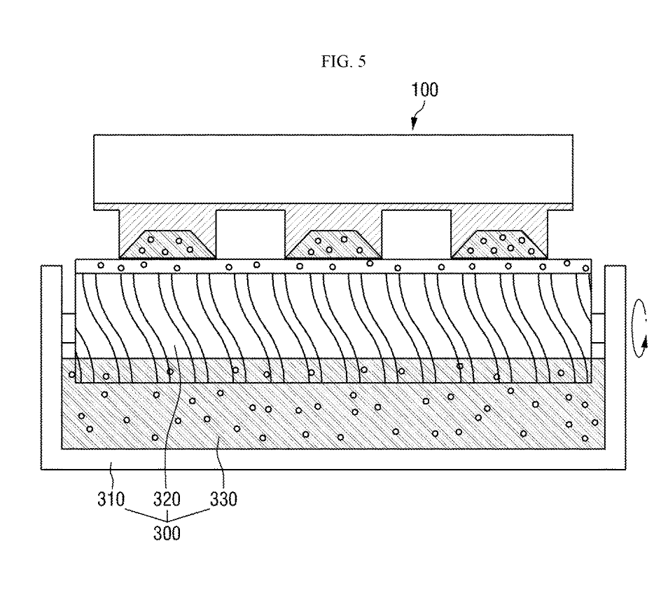

The minimum thickness t2 of the protruding patterns 130b may be greater than the thickness t1 of the flat area portions 130a. Here, the minimum thickness t2 of the protruding patterns 130b may be a minimum thickness among thicknesses of the protruding patterns 130b measured from the surface of the flat area portions 130a which contacts the protruding patterns 130b. In the exemplary embodiment of FIG. 2, the minimum thickness t2 of the protruding patterns 130b may be a distance from the surface of the flat area portions 130a which contacts the protruding patterns 130b to the center of the concave portion C. In an exemplary embodiment, the minimum thickness t2 of the protruding patterns 130b may be about 20 call or more. The minimum thickness t2 of the protruding patterns 130b may be a minimum thickness required for a gravure coating process that may be performed (as described below) to form each of the light diffusing patterns 130c as embedded only within respective ones of the concave portions C. This will be described in detail later with reference to FIG. 5.

The density (e.g., number per unit area) of the protruding patterns 130b in the patterned optical processing layer 130 may increase toward the center of each of the unit cell regions R. In other words, the proportion of the protruding patterns 130b in the patterned optical processing layer 130 may decrease toward a boundary of each of the unit regions R. In the exemplary embodiment of FIG. 1, the protruding patterns 130b may each be a same size and shape while the gaps between adjacent but spaced apart protruding patterns 130b may decrease as one moves toward the center of each of the unit cell regions R. In other words, the gap between adjacent protruding patterns 130b may increase toward the boundary of each of the unit regions R. Specifically, one protruding pattern 130b may be located at the center of each of the unit regions R, and a plurality of protruding patterns 130b may be arranged in a radial fashion around the one central protruding pattern 130b. In this case, the gap between adjacent protruding patterns 130b may decrease toward the one protruding pattern 130b. In other words, the gap between adjacent protruding patterns 130b may increase as the distance from the one protruding pattern 130b increases. That is, the gap between adjacent protruding patterns 130b may be smallest at the center of each of the unit regions R and may be largest at the boundary of each of the unit regions R. In one embodiment (see for example FIG. 11), each unit cell region R corresponds to a point-type light source (e.g., LED) disposed to underlie the center of the corresponding unit cell region R.

The light diffusing patterns 130c may be disposed on the protruding patterns 130b, respectively. Specifically, the light diffusing patterns 130c may be formed within the concave portions C of the protruding patterns 130b, respectively. In other words, the light diffusing patterns 130c may fill the concave portions C. The light diffusing patterns 130c may diffuse and/or reflect (e.g., partially) the backlighting light rays that are incident thereon. (See for example, FIG. 12.)

A lower surface of each of the light diffusing patterns 130c may be parallel to the first surface of the substrate 110. However, the present teachings are not limited thereto. In an exemplary embodiment, the surface of each of the light diffusing patterns 130c may be bent toward the substrate 110. In another exemplary embodiment, the surface of each of the light diffusing patterns 130c may be bent in a direction away from the substrate 110. By controlling the lower surface shape of each of the light diffusing patterns 130c in this way, a direction in which light incident on the light diffusing patterns 130c is diffused or reflected can be controlled.

Each of the light diffusing patterns 130c may include a base member 130c-1 and diffusion particles 130c-2 dispersed within the base member 130c-1.

The base member 130c-1 may be composed of a base material of each of the light diffusing patterns 130c. The base member 130c-1 may surround the diffusion particles 130c-2. The base member 130c-1 may support the diffusion particles 130c-2. The base member 130c-1 may be formed of second resin. Here, the second resin may be transparent. In addition, the second resin may have the property of being cured by light (e.g., UV light) and/or heat. That is, the second resin may be a photocurable resin or a thermosetting resin. Moreover, a refractive index of the second resin may be different from the refractive index of the substrate 110 and/or the refractive index of the first resin. In an exemplary embodiment, the refractive index of the second resin may be higher than the refractive index of the substrate 110 and the refractive index of the first resin. In another exemplary embodiment, the refractive index of the second resin may have a value between the refractive index of the substrate 110 and the refractive index of the first resin. The second resin may be different from the first resin. However, the present teachings are not limited thereto, and the second resin may be the same as the first resin. If the second resin is the same as the first resin, a boundary between each of the light diffusing patterns 130c and a corresponding one of the protruding patterns 130b may not be easily recognized with the naked eye. That is, although the light diffusing patterns 130c and the protruding patterns 130b are formed by different processes, since they are formed of the same material, the boundary between them may be vague.

The diffusion particles 130c-2 may be contained in the base member 130c-1. The diffusion particles 130c-2 may substantially diffuse and/or reflect and/or refract light incident on each of the light diffusing patterns 130c. The diffusion particles 130c-2 may be nanoparticles and may be scattered within the base member 130c-1. In an exemplary embodiment, the diffusion particles 130c-2 may be formed of silicon, TiO₂, SiO₂, ZrO₂, AlO₂, Al, Ag, or a combination of these materials. However, the present teachings are not limited thereto, and the diffusion particles 130c-2 can be formed of various materials having diffusive and/or reflective (e.g., refractive) properties.

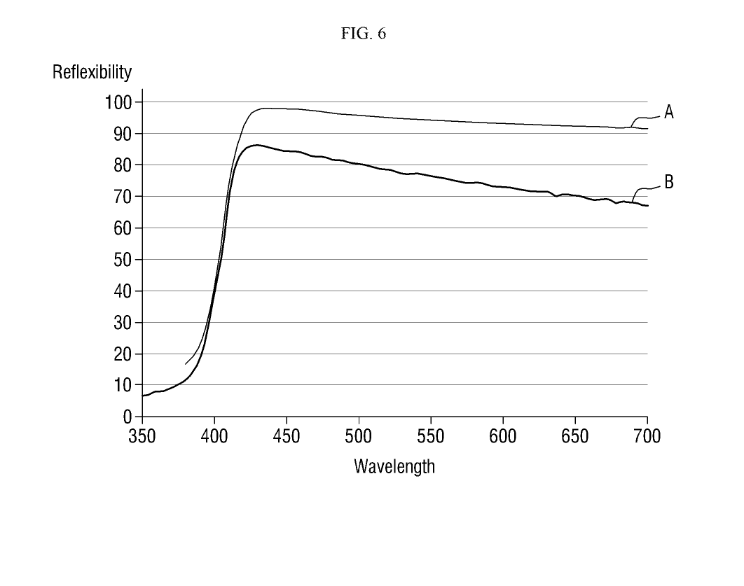

The maximum thickness t3 of the light diffusing patterns 130c may be greater than each of the minimum thickness t2 of the protruding patterns 130b and the thickness t1 of the flat area portions 130a. Here, the maximum thickness t3 of the light diffusing patterns 130c may be a value obtained by subtracting the sum of the thickness t1 of the flat area portions 130a and the minimum thickness t2 of the protruding patterns 130b from a protruding distance of the protruding patterns 130b. In the exemplary embodiment of FIG. 2, the maximum thickness t3 of the light diffusing patterns 130c may be a distance from the center of the concave portion C to the surface of each of the light diffusing patterns 130c. In an exemplary embodiment, the maximum thickness t3 of the light diffusing patterns 130c may be about 20 to 100 μm. In another exemplary embodiment, the maximum thickness t3 of the light diffusing patterns 130c may be about 50 to 100 μm. When the maximum thickness t3 of the light diffusing patterns 130c is 50 μm, the average reflexibility thereof may be approximately 90%. When the maximum thickness t3 of the light diffusing patterns 130c is 100 μm, the average reflexibility thereof may be approximately 95%. The maximum thickness t3 of the light diffusing patterns 130c may be a thickness that makes the reflexibility of the light diffusing patterns 130c as constant as possible with respect to the wavelength of light incident on the light diffusing patterns 130c. This will be described in detail later with reference to FIG. 6.

The proportion of the light diffusing patterns 130c in the patterned optical processing layer 130 may increase toward the center of each of the unit regions R. In other words, the proportion of the light diffusing patterns 130c in the patterned optical processing layer 130 may decrease toward the boundary of each of the unit regions R. In the exemplary embodiment of FIG. 1, the light diffusing patterns 130c may be the same size, and a gap between adjacent light diffusing patterns 130c may decrease toward the center of each of the unit regions R. In other words, the gap between adjacent light diffusing patterns 130c may increase toward the boundary of each of the unit regions R. Since the light diffusing patterns 130c are disposed on the protruding patterns 130b, the arrangement of the light diffusing patterns 130c may correspond to the arrangement of the protruding patterns 130b.

As described above, the optical plate 100 according to the current embodiment can efficiently diffuse light by using the patterned light diffusing patterns 130c that are monolithically integrally formed with the flat area portions 130a and yet have relatively large thicknesses.

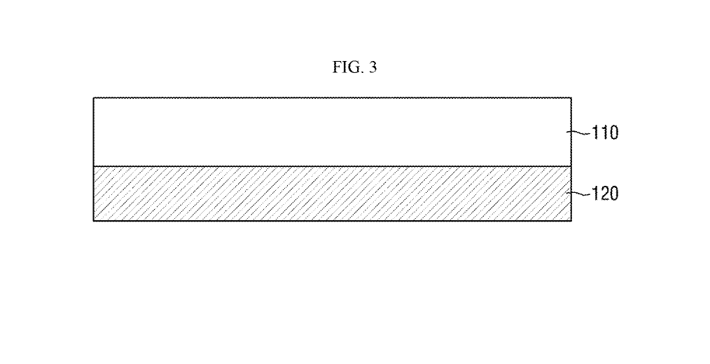

A method of manufacturing the optical plate 100 according to an embodiment of the present disclosure of invention will now be described with reference to FIGS. 3 through 5. FIGS. 3 through 5 are cross-sectional views illustrating steps of a method of mass production manufacturing of the optical plate 100 of FIG. 1. For simplicity, elements substantially identical to those of FIGS. 1 and 2 are indicated by like reference numerals, and a redundant description thereof will be omitted.

Referring to FIG. 3, a preliminary pattern layer 120 is formed on a surface of a substrate 110. In an exemplary embodiment, the preliminary pattern layer 120 may be formed of the first resin (having a respective first refractive index, n1). However, the material that forms the preliminary pattern layer 120 is not limited to the first resin, and the preliminary pattern layer 120 may also be formed of a metal material. A thickness of the preliminary pattern layer 120 may be smaller than or equal to the sum of a thickness t1 of a flat area portions 130a, a minimum thickness t2 of protruding patterns 130b, and a maximum thickness t3 of light diffusing patterns 130c.

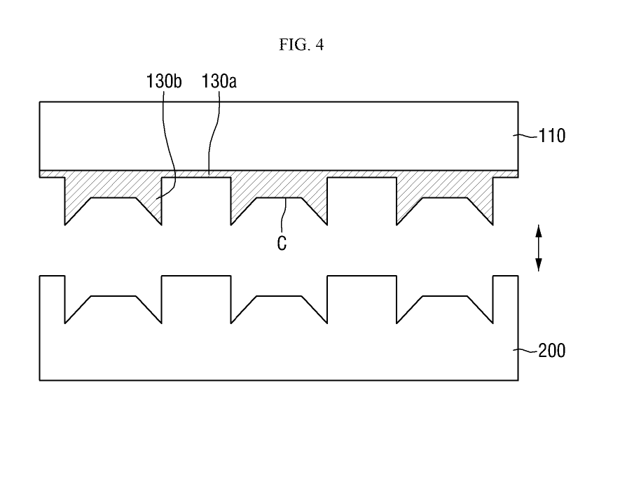

Referring to FIG. 4, the preliminary pattern layer 120 formed on the surface of the substrate 110 is at this stage easily deformable and pressed with a stamp 200 to thereby give it a correspondingly conforming shape. Here, the stamp 200 may have a shape corresponding to the shape of the flat area portions 130a and the protruding patterns 130b. In addition, the stamp 200 may be formed of a hard and transparent material (e.g., one that lets UV light through, for example quartz). Also, the stamp 200 may be formed of a material that is not sensitive to heat and/or pressure.

Specifically, a surface of the stamp 200 which corresponds to the shape of the flat area portions 130a and the protruding patterns 130b may be placed to face the preliminary pattern layer 120. Then, the substrate 110 or the stamp 200 may be moved to bring a surface of the preliminary pattern layer 120 into contact with the surface of the stamp 200 which corresponds to the shape of the flat area portions 130a and the protruding patterns 130b. In this state, if the distance between the substrate 110 and the stamp 200 is reduced further, the shape of the preliminary pattern layer 120 may change into the shape of the flat area portions 130a and the protruding patterns 130b. Here, if the preliminary pattern layer 120 is formed of the first resin, the first resin may be cured by irradiating with a polymer-curing light (e.g., UV light) and/or transmitting heat (e.g., with use of IR light) to the preliminary pattern layer 120 through the stamp 200. The first resin cured after its shape was changed as described above may become the flat area portions 130a and the protruding patterns 130b.

The above process is called an imprinting process. The imprinting process is not a complicated, multi-stage process like a photolithography process but is a simple imprinting process using the stamp 200. Therefore, the imprinting process is a low-cost process usable in mass production. In addition, the imprinting process is easily applicable to a large-area substrate, and the same pattern can be formed on a plurality of substrates by using one stamp 200 in cookie cutter style. Therefore, the imprinting process may be suitable for mass production. That is, the flat area portions 130a and the protruding patterns 130b can be mass-produced on a large-area substrate at low costs by using the imprinting process. Furthermore, the thick protruding patterns 130b, each having a concave portion C at an end thereof, can be formed easily by using the imprinting process.

In another embodiment, if the preliminary pattern layer 120 is formed of a metal material (e.g., a ductile and thus plastically deformable one), and when the preliminary pattern layer 120 is pressed with the stamp 200, heat may be transmitted to the preliminary pattern layer 120 through the stamp 200, so that the so-heated preliminary pattern layer 120 can be easily deformed. After the shape of the preliminary pattern layer 120 changes into the shape of the flat area portions 130a and the protruding patterns 130, the preliminary pattern layer 120 may be cooled to thereby form and retain the flat area portions 130a and the protruding patterns 130b.

The above process is called a hot pressing process. The hot pressing process is performed to deform, for example, a ductile metal with heat and pressure and is used in various fields. Like the imprinting process, the hot pressing process is a process using the stamp 200. Therefore, the hot pressing process is a low-cost process, applicable to a large-area substrate, and suitable for mass production. Using the hot pressing process, the flat area portions 130a and the protruding patterns 130b can be mass-produced on a large-area substrate at low costs. In addition, the hot pressing process may be advantageous in forming thick and complicated patterns. That is, the thick protruding patterns 130b, each having the concave portion C at an end thereof, can be easily formed by using the hot pressing process.

Referring to FIG. 5, after the preliminary pattern layer 120 is pressed with the stamp 200, light diffusing patterns 130c are formed within the pre-formed concave portions C of the protruding patterns 130b, respectively. Here, the light diffusing patterns 130c may be formed by a gravure coating process using a gravure coating apparatus 300.

Specifically, the gravure coating process 300 may include a bathtub like container 310, a roller 320, and a liquid solution 330 for forming the light diffusing patterns 130c. The solution 330 may be a mixture of diffusion particles 130c-2 and of the second resin. The roller 320 and the solution 330 may be located within the bathtub 310. The gravure coating apparatus 300 may rotate the roller 320 and thus coat the solution 330 onto the concave portions C by moving the solution 330 up the bath 310 using pumping grooves (e.g., screw like ones) formed in a surface of the roller 320.

Although not shown in the drawing, after the solution 330 is coated onto the concave portions C so as to fill those concave portions C, light (e.g., UV and/or IR) and/or heat may be provided to the coated-on solution 330 so as to cure that coated-on solution 330, thereby forming the light diffusing patterns 130c. Here, the second resin may be cured to become a base member 130c-1.

To coat desired portions using the gravure coating process, the desired portions should protrude. In particular, for the sake of process safety, the desired portions may protrude more than at least 20 μm. That is, the minimum thickness t2 of the protruding patterns 130b that are to be coated in the optical plate 100 should be 20 μm or more. Additionally, to protect the flat area portions 130a, an easily removable mask may be optionally pre-coated onto the flat area portions 130a.

In addition, portions of the flat area portions 130a which do not overlap the protruding patterns 130b are portions inevitably formed by an imprinting process or a hot pressing process. To reduce the amount of material used, a thickness of these portions of the flat area portions 130a should be minimized. That is, while the thickness t1 of the flat area portions 130a is 2 to 5 μm as described above, the thickness of these portions may be less than 2 to 5 μm.

As described above, the thick light diffusing patterns 130c may be formed only on the concave portions C of the protruding patterns 130b and not on the flat area portions 130a by using the gravure coating process. That is, the concave portions C may naturally be filled with the solution 330 by the gravure coating process and then cured to form the light diffusing patterns 130c having a large thickness of, for example, 20 to 100 μm.

The reflexibility of the light diffusing patterns 130c with respect to the thickness of the light diffusing patterns 130c will now be described with reference to FIG. 6. FIG. 6 is a graph illustrating the reflexibility (e.g., percentage of incident light of respective wavelength that is reflected) of the light diffusing patterns with respect to the wavelength of light incident onto the light diffusing patterns.

In FIG. 6, plot A is a graph of reflexibility of the light diffusing patterns 130c according to an embodiment of the present teachings with respect to the wavelength of light incident on the light diffusing patterns 130c in a case where the maximum thickness t3 of the light diffusing patterns 130c is 100 μm. Plot B is a graph of reflexibility of conventional light diffusing patterns with respect to the wavelength of light incident on the light diffusing patterns in a case where a maximum thickness of the light diffusing patterns is 10 μm.

Referring first to the graph B, if the maximum thickness of the light diffusing patterns is 10 μm, as the wavelength of light incident on the light diffusing patterns increases, the reflexibility of the light diffusing patterns decreases sharply. That is, the light diffusing patterns having a maximum thickness of 10 μm cannot diffuse and/or reflect light of the longer wavelengths (e.g., 700 nm) in substantially the same way as they do the shorter wavelengths (e.g., 400 nm) and a discoloration may then be perceived by the surface. In other words, a color difference may be seen to occur in a display area of a display device.

On the other hand, referring to the graph A, if the maximum thickness t3 of the light diffusing patterns 130c is at least 100 μm, the reflexibility of the light diffusing patterns 130c does not decrease sharply even as the wavelength of light incident on the light diffusing patterns 130c increases. That is, the light diffusing patterns 130c having a thickness of at least 100 μm diffuses light of a long wavelength relatively well. Accordingly, it is possible to prevent the color difference in the display area of the display device.

As described above, by using the method of manufacturing the optical plate 100 according to the current embodiment, the optical plate 100 including the thick, patterned light diffusing patterns 130c can be mass-produced at low costs. In addition, if both the first resin and the second resin have photo-curability and if the above-described imprinting process (or the hot pressing process) and the above-described gravure coating process are performed in-line, process efficiency can be improved.

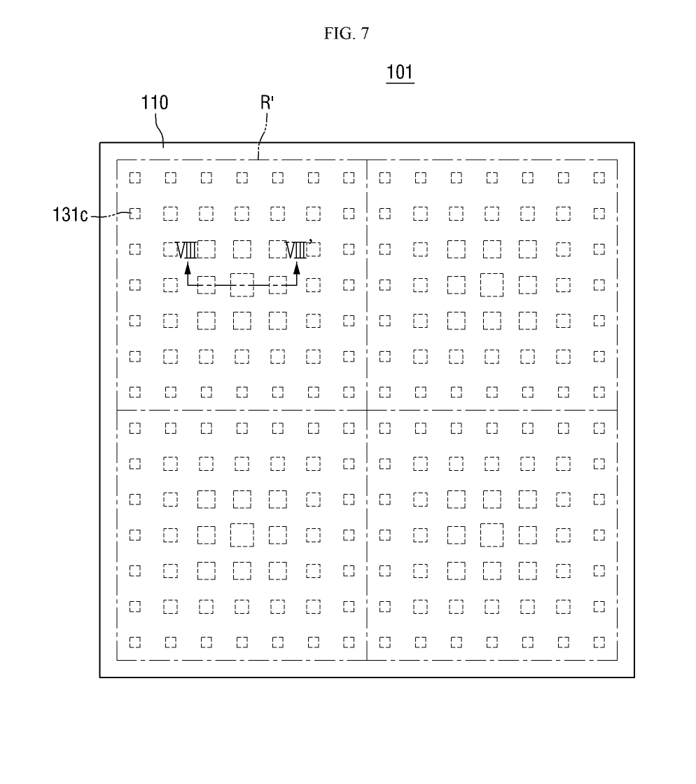

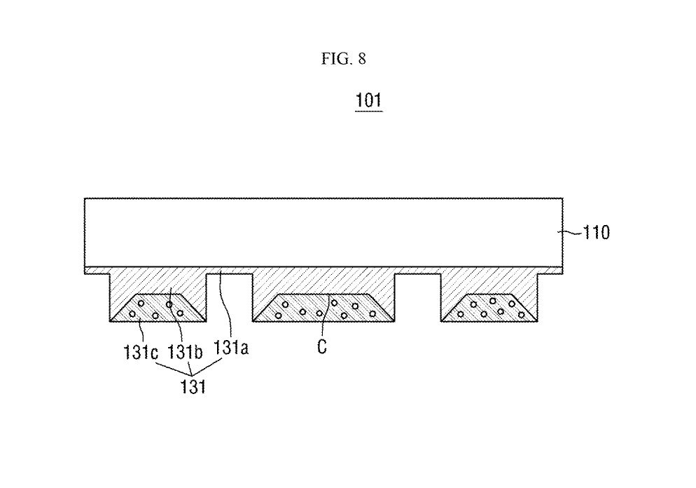

An optical plate according to another embodiment of the present teachings will now be described with reference to FIGS. 7 and 8. FIG. 7 is a top plan view of an optical plate 101 according to another embodiment in accordance with the present disclosure. FIG. 8 is a cross-sectional view taken along the line VIII-VIII′ of FIG. 7. For simplicity, elements substantially identical to those of FIGS. 1 and 2 are indicated by like reference numerals, and a redundant description thereof will be omitted.

Referring to FIGS. 7 and 8, the optical plate 101 according to the current embodiment may include a patterned optical processing layer 131 which includes flat area portions 131a, a plurality of protruding patterns 131b if differing widths, and a plurality of light diffusing patterns 131c. Here, the protruding patterns 131b may be arranged at regular intervals. However, the sizes (e.g., top plan view areas) of the protruding patterns 131b may increase when moving toward a center of each of a plurality of unit cell regions R′. Specifically, a protruding pattern 131b located at the center of each of the unit regions R′ may be largest, and protruding patterns 131b adjacent to a boundary of each of the unit regions R′ may be smallest in terms of top plan view area. Accordingly, the size and arrangement of the light diffusing patterns 131c may vary according to the size and arrangement of the protruding patterns 131b. In addition, exposed portions of the flat area portions 131a may vary with location.

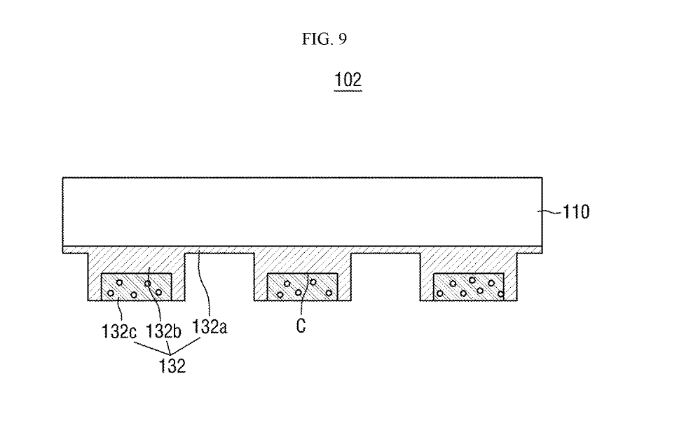

An optical plate according to another embodiment of the present disclosure of invention will now be described with reference to FIG. 9. FIG. 9 is a cross-sectional view of an optical plate 102 according to this other embodiment. For simplicity, elements substantially identical to those of FIG. 2 are indicated by like reference numerals, and a redundant description thereof will be omitted.

Referring to FIG. 9, the optical plate 102 according to the current embodiment may include a patterned optical processing layer 132 which includes flat area portions 132a, a plurality of protruding patterns 132b, and a plurality of light diffusing patterns 132c. Here, a concave or otherwise inset portion C formed at an end of each of the protruding patterns 132b may have a different shape from the shape in the previous embodiments. Specifically, a cross-section of the concave portion C may be quadrangular. That is, a center of the concave portion C may be parallel to a surface of a substrate 110, and sides of the concave portion C may be essentially perpendicular to the surface of the substrate 110 (although some amount of draft angle may be desired for disengaging the stamp). Accordingly, the light diffusing patterns 132c may also have a different shape from the shape in the previous embodiments.

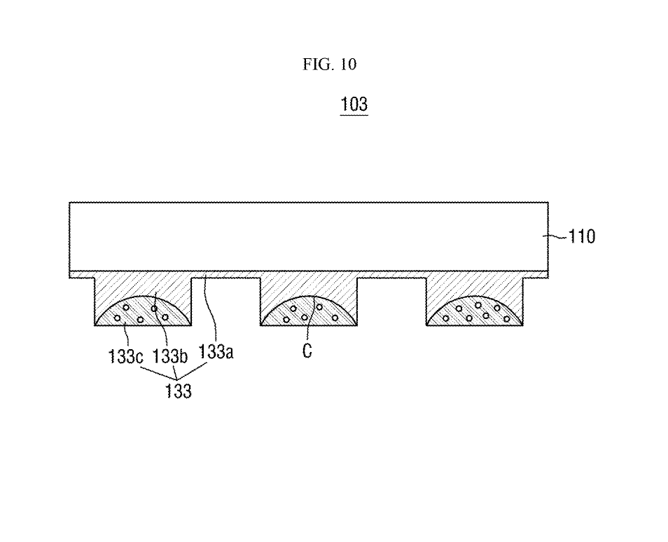

An optical plate according to another embodiment of the present disclosure will now be described with reference to FIG. 10. FIG. 10 is a cross-sectional view of an optical plate 103 according to this other embodiment. For simplicity, elements substantially identical to those of FIG. 2 are indicated by like reference numerals, and a redundant description thereof will be omitted.

Referring to FIG. 10, the optical plate 103 according to the current embodiment may include an patterned optical processing layer 133 which includes flat area portions 133a, a plurality of protruding patterns 133b, and a plurality of light diffusing patterns 133c. Here, a concave portion C formed at an end of each of the protruding patterns 133b may have a different shape from the shapes in the previous embodiments. Specifically, a cross-section of the concave portion C may be curved such as being semi-circular or semi-elliptical.

As shown in FIGS. 9 and 10, the concave portion C may have various shapes. Accordingly, an optical pattern that fills the concave portion C may have various shapes. Thus, light-diffusing properties of the optical plate 102 or 103 can be adjusted by selecting an appropriate shape of the optical pattern.

A backlight assembly according to an embodiment of the present disclosure of invention will now be described with reference to FIGS. 11 and 12. FIG. 11 is a plan view of a backlight assembly 1000 according to an embodiment. FIG. 12 is a cross-sectional view taken along the line XII-XII′ of FIG. 11. For simplicity, elements substantially identical to those of FIGS. 1 and 2 are indicated by like reference numerals, and a redundant description thereof will be omitted.

Referring to FIGS. 11 and 12, the backlight assembly 1000 according to the current embodiment includes an optical plate 100 and a light sources layer 400. The backlight assembly 1000 according to the current embodiment may further include a reflection plate 500 disposed under the light sources layer 400.

The optical plate 100 of FIGS. 11-12 may be the optical plate 100 according to the embodiment of FIGS. 1 and 2, and thus a redundant description thereof will be omitted.

The light sources of layer 400 may be fixed in a predetermined position relative to the optical plate 100. Specifically, the light sources layer 400 may be placed so respective ones of the light sources (only one shown in FIG. 12) face the patterned optical processing layer 130 of the optical plate 100. In addition, the light sources 400 may be separated from the optical plate 100 by a predetermined distance. The light sources 400 may be interposed between the optical plate 100 and the reflection plate 500. The light sources 400 may each be respectively disposed to be co-centric with respective ones of the plurality of unit cell regions R. In other words, in an exemplary embodiment, a center of each light source 400 may overlap the center of its corresponding one of the unit cell regions R.

The reflection plate 500 may be located under the light sources 400. In addition, a surface of the reflection plate 500 may face the patterned optical processing layer 130 of the optical plate 100. In an exemplary embodiment, the reflection plate 500 may be substantially parallel to the optical plate 100 and may be made of an appropriate metal or other reflective material.

Although not shown in the drawings, the backlight assembly 1000 may further include a light guide plate (LGP). In an exemplary embodiment, the LGP may be interposed between the light sources 400 and the optical plate 100. In another exemplary embodiment, the LGP may be disposed above the optical plate 100. That is, the optical plate 100 may be interposed between the LGP and the light sources 400.

Light generated from the light source 400 may be guided by the optical plate 100 and the reflection plate 500 to exit the backlight assembly 1000. Specifically, referring to FIG. 12, light rays generated from the light source 400 may pass with substantially no refraction through portions of the flat area portions 130a which do not overlap light diffusing patterns 130c to come out of the backlight assembly 1000. In addition, light rays generated from the light source 400 may be diffused and/or reflected by the light diffusing patterns 130c and the reflection plate 500 and then pass through the portions of the flat area portions 130a which do not overlap the light diffusing patterns 130c to finally come out of the backlight assembly 1000. Here, since relatively more light diffusing patterns 130c are placed more densely in regions that are co-central to the respective light source 400, light generated from the light source 400 and having relatively maximum luminance near the center of the light source 400 can nonetheless be delivered in a more uniform way to regions far away from the light source 400 by use of partial reflections. That is, since the gaps between adjacent ones of the light diffusing patterns 130c can be varied as desired, the gaps may be empirically varied to find patterns that prevent the formation of luminance hot spots for specific light sources 400 and to thus enable light generated from the light sources 400 to more uniformly come out of the backlight assembly 1000.

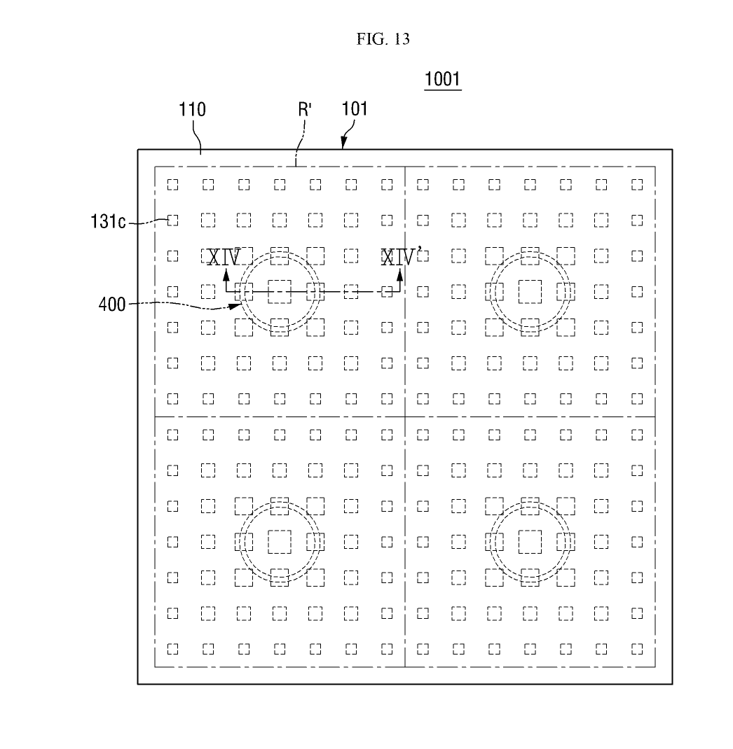

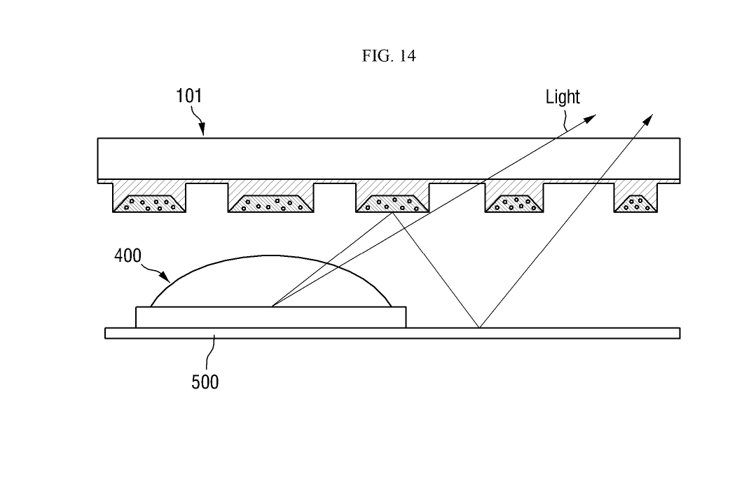

A backlight assembly according to another embodiment of the present disclosure of invention will now be described with reference to FIGS. 13 and 14. FIG. 13 is a top plan view of a backlight assembly 1001 according to another embodiment of the present disclosure. FIG. 14 is a cross-sectional view taken along the line XIV-XIV′ of FIG. 13. For simplicity, elements substantially identical to those of FIGS. 7, 8, 11 and 12 are indicated by like reference numerals, and a redundant description thereof will be omitted.

Referring to FIGS. 13 and 14, the backlight assembly 1001 according to the current embodiment may use the optical plate 101 according to the embodiment of FIGS. 7 and 8. That is, the backlight assembly 1001 according to the current embodiment can adjust the size (e.g., top plan view areas) of the light diffusing patterns 131c to prevent the formation of luminance hot spots due to the basic luminance distribution pattern of the utilized light source 400 and to thus enable light generated from the light source 400 to more uniformly come out of the backlight assembly 1001.

Embodiments in accordance with the present teachings may provide at least one or more of the following advantages.

That is, patterned light diffusing patterns having a large thickness can efficiently diffuse light.

In addition, an optical plate including the light diffusing patterns can be mass-produced at low costs.

Moreover, the patterning of the light diffusing patterns can be custom tailored to counter-compensate for luminance hot spots that otherwise would be generated by the utilized light sources 400.

Additionally, the number of utilized light sources 400 may be reduced since the light ray reflection and/or diffusion patterns may be adjusted to allow for more uniform light output even if the utilized light sources 400 are spaced relatively far apart.

However, the effects of the present disclosure of invention are not restricted to the ones set forth herein. The above and other effects of the present disclosure will become more apparent to one of daily skill in the art to which the present teachings pertain by referencing the entirety of this disclosure which includes the claims.

While the present teachings have been particularly shown and described with reference to exemplary embodiments thereof, it will be understood by those of ordinary skill in the art and in light of the present disclosure that various changes in form and details may be made therein without departing from the spirit and scope of the present teachings. It is therefore desired that the present embodiments be considered in all respects as illustrative and not restrictive.

What is claimed is:

1. An optical plate comprising:
a light-passing substrate; and
a patterned optical processing layer disposed on the substrate,
wherein the patterned optical processing layer comprises:
flat area portions;
a plurality of spaced apart protruding patterns which are located on or between the flat area portions and have concave portions formed at respective free ends thereof; and
a plurality of light diffusing patterns which are located within the concave portions, respectively.

2. The optical plate of claim 1, wherein a minimum thickness of the protruding patterns is greater than a thickness of the flat area portions.

3. The optical plate of claim 2, wherein the minimum thickness of the protruding patterns is 20 μm or more.

4. The optical plate of claim 1, wherein a thickness in the protruding direction of the light diffusing patterns is greater than the minimum thickness of the protruding patterns.

5. The optical plate of claim 4, wherein the protruding direction thickness of the light diffusing patterns is 20 to 100 μm.

6. The optical plate of claim 1, wherein the flat area portions are integrally formed with the protruding patterns.

7. The optical plate of claim 1, wherein each of the light diffusing patterns comprises a base member and diffusion particles distributively contained within the base member.

8. The optical plate of claim 7, wherein the flat area portions and the protruding patterns are formed of a first resin, and the base member is formed of a different second resin, wherein the first resin and the second resin are each curable by use of at least one of light and heat.

9. The optical plate of claim 1, wherein the substrate comprises one or more unit cell regions, and an area occupying density of the light diffusing patterns in the patterned optical processing layer increases toward a center of each of the unit cell regions.

10. The optical plate of claim 9, wherein a gap between adjacent light diffusing patterns decreases toward the center of each of the unit regions.

11. The optical plate of claim 9, wherein a size of the light diffusing patterns increases toward the center of each of the unit regions.

12. A method of manufacturing an optical plate, the method comprising:
forming on a substrate, a plurality of flat area portions and a plurality of protruding patterns, where the protruding patterns protrude from or between the flat area portions and have concave portions formed at respective free ends thereof; and
forming a plurality of light diffusing patterns within the concave portions, respectively.

13. The method of claim 12, wherein the forming of the flat area portions and the protruding patterns comprises:
forming a preliminary pattern layer on the substrate; and
pressing the preliminary pattern layer with a stamp having a shape corresponding to a shape of the flat area portions and the protruding patterns.

14. The method of claim 13, wherein the preliminary pattern layer is formed of first resin having the property of being curable by at least one of light and heat.

15. The method of claim 13, further comprising irradiating light or transmitting heat to the preliminary pattern layer through the stamp during or after the pressing of the preliminary pattern layer with the stamp.

16. The method of claim 12, wherein the forming of the light diffusing patterns comprises filling the concave portions with a mixture of diffusion particles and second resin, which second resin has the property of being curable by at least one of light and heat, the filling being carried out by using a gravure coating apparatus.

17. The method of claim 16, further comprising irradiating light or transmitting heat to the mixture after the filling of the concave portions with the mixture.

18. A backlight assembly comprising:
an optical plate which comprises a substrate and a patterned optical processing layer located on the substrate; and
a light source which faces the patterned optical processing layer of the optical plate,
wherein the patterned optical processing layer comprises:
flat area portions;
a plurality of protruding patterns which are located on or between the flat area portions and have concave portions formed at respective ends thereof; and
a plurality of light diffusing patterns which are located on the concave portions, respectively.

19. The backlight assembly of claim 18, wherein the substrate comprises one or more unit cell regions, and a proportion of the light diffusing patterns in the patterned optical processing layer increases when moving toward a center of each of the unit cell regions.

20. The backlight assembly of claim 19, wherein a center of the light source overlaps the center of each of the corresponding unit cell region.
